(19) United States
(12) Patent Application Publication
(10) Pub. No.: US 2026/0211604 A1
(43) Pub. Date: Jul. 23, 2026

(54) VIDEO CONFERENCING SECURITY FACILITY

(71) Applicant: Bulletproof Property Management, LLC, Cheyenne, WY (US)

(72) Inventor: Bennet Langlotz, Dallas, TX (US)

(73) Assignee: Bulletproof Property Management, LLC, Cheyenne, WY (US)

(21) Appl. No.: 19/032,427

(22) Filed: Jan. 20, 2025

(51) Int. Cl. G06F 3/14; G06F 3/0481; G06F 3/04845

(52) U.S. Cl. CPC G06F 3/1454; G06F 3/0481; G06F 3/04845

(57) ABSTRACT

A video conferencing security facility has a controller, a sharing user display connected to the controller and operable to generate a screen image displaying a plurality of initial application window portions, and a sharing user input device connected to the controller. A viewing user display is connected to the controller, which is operable to transmit a shared depiction of the screen image to the viewing user display. The controller is operable in response to operation of the sharing user input device revealing an additional application window portion on the sharing user display to prevent transmission of the additional application window portion to the viewing user display. The controller may be operable in response to operation of the sharing user input device to reveal an additional application window portion on the sharing user display in response to a grant of consent.

### FIELD OF THE INVENTION

This application relates to video conferencing software and systems, and more particularly to screen sharing security and privacy matters.

### BACKGROUND AND SUMMARY OF THE INVENTION

Video conferencing systems, provide voice and visual communication between individuals and among groups. These systems provide screen sharing, that enables conference participants to view a common screen. A user whose screen is shared, will typically be presented with options of what to share. among these are all the different open windows on their screens.

Selecting to share a window has the advantage of ensuring that the user is not inadvertently sharing other windows or desktop or background items on the screen in advertently. This avoids. the sharing of improper, confidential matters, or other embarrassing or inappropriate subject matter. However, in some instances, this has a disadvantage of inconvenience, when a user might wish to be discussing several documents or moving among several different documents rapidly within a conference.

When displaying and sharing multiple documents, and moving among these documents, the user may prefer to select an entire screen to share. This enables windows to be clicked to be brought to the front of the view for sharing, or moved aside, perhaps to other screens, or to be minimized to view windows behind. While this is effective, it carries with it certain privacy and security risks.

There may be items on the sharing users screen that are confidential or otherwise inappropriate to share. These may be inadvertently revealed by minimizing a window or by shifting a window. They may also be revealed by inadvertently clicking, a partially hidden window, bringing it to the front for viewing. In addition, a user's desktop may contain elements such as shortcuts that reveal unwanted or inappropriate information.

There may also be disadvantages or challenges relating to a user inadvertently selecting the wrong window to share, potentially revealing unwanted information to conference participants.

The preferred embodiment of the invention overcomes these and other disadvantages by providing a video conferencing security facility with a controller, a sharing user display connected to the controller and operable to generate a screen image displaying a plurality of initial application window portions, and a sharing user input device connected to the controller. A viewing user display is connected to the controller, which is operable to transmit a shared depiction of the screen image to the viewing user display. The controller is operable in response to operation of the sharing user input device revealing an additional application window portion on the sharing user display to prevent transmission of the additional application window portion to the viewing user display. The controller may be operable in response to operation of the sharing user input device to reveal an additional application window portion on the sharing user display, to display on the sharing user display a consent request message. The controller may be operable in response to a grant of consent to reveal the additional application window portion on the sharing user display.

### BRIEF DESCRIPTION OF THE DRAWINGS

FIG. 1 is a block diagram of a system according to a preferred embodiment.

FIGS. 2A-C are a depiction of a first sequence of operations of the embodiment of FIG. 1.

FIG. 3A-C are a depiction of a second sequence of operations of the embodiment of FIG. 1.

FIG. 4A-C are a depiction of a third sequence of operations of an alternative embodiment.

The same reference numerals refer to the same parts throughout the various figures.

### DESCRIPTION OF THE CURRENT EMBODIMENT

An embodiment of the video conferencing security facility of the present invention is shown and generally designated by the reference numeral 10.

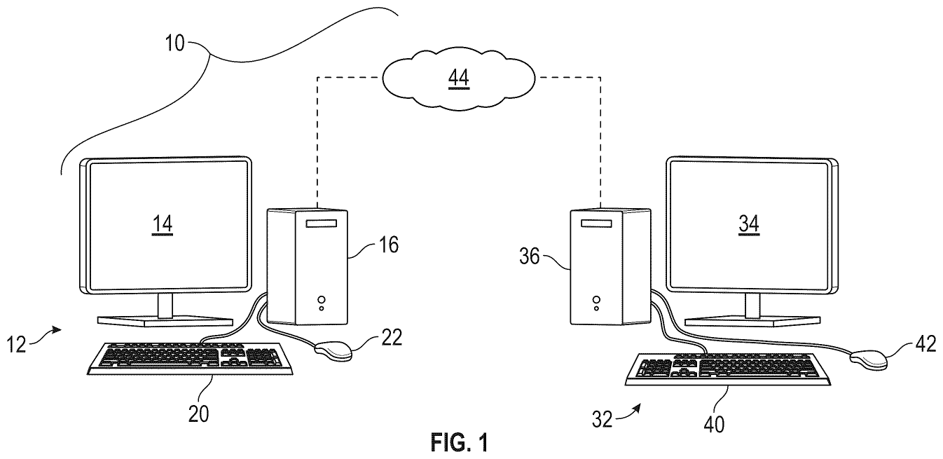

FIG. 1 shows a communication system 10 according to a preferred embodiment. A sender or sharing user computer system 12 has a sharing user display 14, processor 16, keyboard input device 20, and mouse input device 22. A receiver or sharing user computer system 12 has a sharing user display 14, processor 16, keyboard input device 20, and mouse input device 22. A receiver or viewing user computer system 32 has a sharing user display 34, processor 36, keyboard input device 40, and mouse input device 42. The processors are connected to each other, preferably via a cloud 44 or other network such as the Internet. This enables communication between the users via a video conferencing system that enables screen sharing by the sharing user with the viewing user. In preferred application, the sharing and viewing goes both ways but for this example the users are identified as such for clarity.

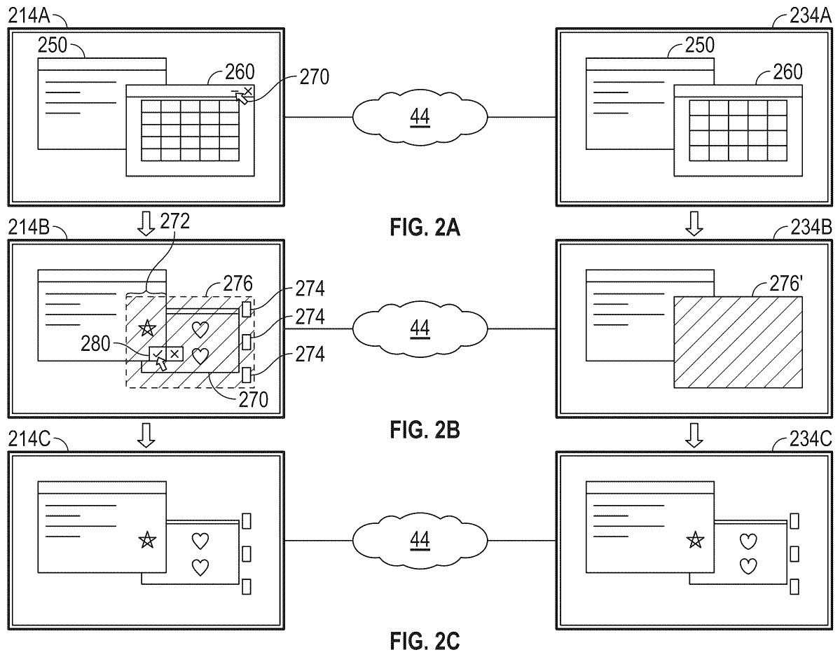

FIGS. 2A-C show a sequence of operations in which the sharing user with screen 14 is viewing an image 214A that is shared and displayed for viewer as image 234A. In the first step in a sharing sequence, FIG. 2A depicts a first window 250 and an overlapping second window 260. The user's cursor, driven by mouse input device 22 is positioned over the minimize button of window 260. The sharing user screen image 234A depicts the same windows and screen image as the sharing user's.

2B shows the sharing user has clicked to minimize window 260, now revealing some elements on the display. The revealed elements include a third hidden window 270 shown with heart icons to symbolize that this may include personal or confidential information that the sharing user does not wish to share. Also revealed is a lower right portion 272 of window 260, that includes a previously hidden image depicted as a star symbol. Also revealed are three desktop icons 274. In the prior art systems, all this information would have been instantly transmitted to the viewing user's display.

In the preferred embodiment, the sharing user display 214B now shows a highlighted area 276 that corresponds to the minimized window 260. This preferably shows the sharing user all the content that the minimization reveals, in addition to the highlighting. The highlighting may be with a color or pattern overlay on the entire area 276, or the frame, and should be at least partially transparent to reveal the information about to be revealed for sharing user evaluation. It may be a cautionary color that tints the entire area yellow or pink, for example, or with diagonal bars in the form of cross hatching. Other highlighting approaches may include flashing or animated patterns on the area or periphery.

Within the area 276 is a query box 280 that offers the sharing user two choices about the highlighted area: consent to display it to the viewing user by clicking an accept box (green check) or revoke the minimization and display by clicking a cancel box (red X). If cancel is selected, the user may opt to entirely cancel sharing to clean up the desktop before sharing to reveal the area behind the minimized window 276, or the system may offer other options to the sharing user to minimize other windows. One embodiment may allow the sharing user's screen to remain fully controllable so that when offered the highlighted area and query box, the sharing user may simply click to minimize the window 270 that included private matters not desired for sharing. Other elements may be manipulated on the screen until the sharing user is ready to consent to sharing.

While the sharing user sees the highlighted revealed area 276 before consenting or cancelling the minimization, the viewing user sees a blank or gray area 276′. In alternative embodiments, this may simply be the original window 260 so that the viewing user is unaware that the sharing user has minimized the window and may be deciding and adjusting before agreeing to share the revealed area.

Display 214C depicts the sharing user screen after consent is granted, and display 234C shows the transmitted display.

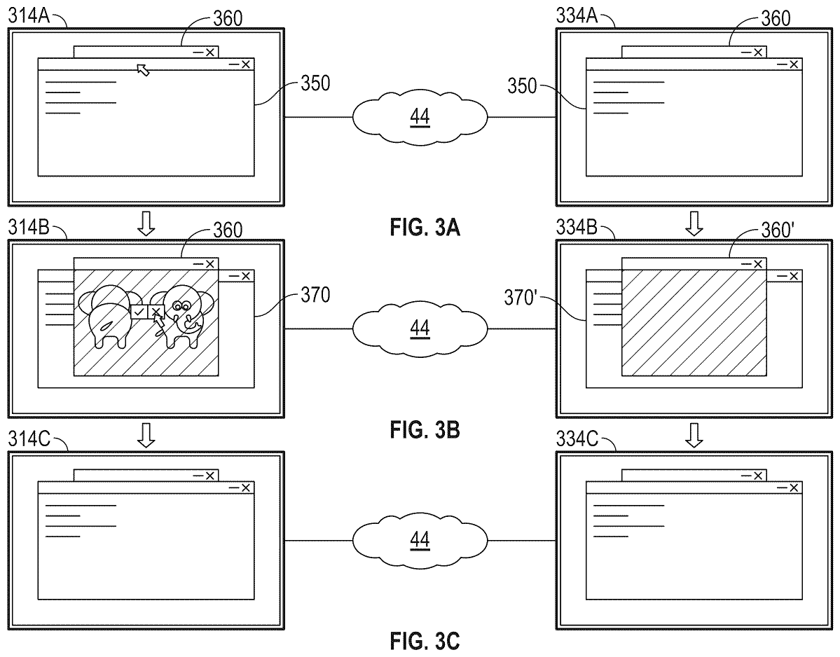

FIGS. 3A-C depict a similar sequence in which the sharing user reveals a screen area and is offered the chance to correct or consent before it is revealed to the viewing user. In this instance a first window 350 mostly obscures all but a small portion of an underlying window 360 as displayed on the sharing user display 314A. Both are displayed on the viewing user screen 334A. The sharing user's cursor has clicked an exposed portion of the underlying window 360, possibly inadvertently. This normally bring the underlying window to the front for viewing or sharing. But like the FIG. 2 example, the concealed portion of the underlying window that was previously concealed is now displayed only to the sharing user as a highlighted area and to the viewing user as a blank area or as the original depiction. The same consent process and options are offered and employed. FIG. 3C shows the consented window being displayed for the viewing user.

Besides minimizing the clicking to bring a window to the front, the preferred system may be used for any display activity by the sharing user that reveals previously unrevealed area or content, such as dragging and moving a window, resizing a window, opening a new window, or acting within an application such as a web browser to switch to a new page or to open a new browser window or popup.

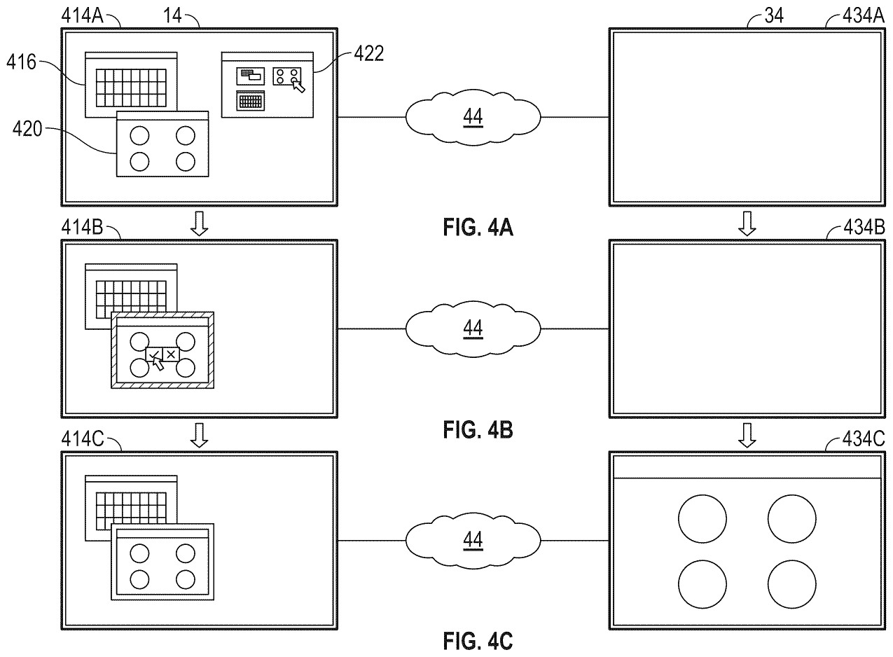

FIGS. 4A-C shows an alternative system that may be combined with the above system or used independently. This resolves the initial screen sharing to help the sharing user avoid inadvertently sharing the wrong window, or the entire screen instead of a desired window. The initial sharing user display in FIG. 4A shows a screen image 414A having several open windows 416, 420, and a third window screen sharing window 422 for the teleconferencing screen sharing application. As is known, the screen sharing window 422 includes representations of each of the windows 416, 420 and the screen 414 for the user to select which to share. The sharing user makes a selection, in this case window 420. Conventionally, that window would be shared automatically.

In the preferred system, nothing including the selected window is yet shared, as depicted in viewing user screen image 434A. Alternatively, the viewing user may have a screen normally populated including a conference application window that is blank or shown in a non-sharing mode such as displaying the image of the other user, as long as the sharing user screen or window is not yet shared.

FIG. 4B shows that the sharing user has selected in the teleconferencing app window 422 the window 420 (shown with four circles). Instead of sharing this yet, the system prompts the sharing user with a highlighted window of what is understood to have been selected for sharing. The system offers a consent query prompt, and only if the sharing user selects “Yes” does it share the selected window as shown on viewing user screen 434C. This ensures that the sharing user does not make a mistake when looking at the small thumbnail representations of the windows and screens offered as options to share.

To avoid needless prompting and consent when switching among windows during a screen sharing session, the system may also have a “memory” for approved or qualified windows or screen areas. If a window is initially approved for sharing it can be considered safe and sharable with the same viewer in the same session. This may be a default rule, or may be deselected at the user's choice in application setting, or may be offered as an “ask me each time” with a third option on the consent prompt query to approve it for the rest of the session.

Also, different applications and categories of applications may be treated differently by default. Depending on the user, the typical sensitivity to content for applications may vary. Some may find that personal finance software applications are always confidential, and never shared, so these may be an example of an “always block, never share” without prompting, so that a full screen share with this visible will always hide for the viewing user that window or portion displayed to the sharing user. Email applications may be similar, with potentially confidential emails from other clients needing to be kept from view by a different client with whom the screen is being shared. This can be a concern as new emails can arrive during the session unbeknownst to the sharing user. Media or gaming applications may be similarly subjected to default hiding due to the potential for inappropriate or unbusinesslike content being displayed. Other applications may be considered “likely share” application, such as word processing, spreadsheet, and document display applications (pdf). Screen elements may also be given a range of default treatment, such as “conceal all desktop shortcuts and icons” or “conceal all screen menu bars” or “conceal all tabs in browser” or “conceal all drop-down menus”.

The nature of the viewing user may also be a factor in determining what to display and defaults for displaying vs hiding vs asking. A spouse may have one set of rules different from a client, which would be different from a subordinate, vs a supervisor. An employer might insist that employees reveal the entire screen to a supervisor, but have much more restrictive display rules for that employee sharing with a customer.

There may then be different treatment for different application types and screen elements. These may range from “always display without asking,” or “always ask,” or “never display”.

I claim:

1. A video conferencing security facility comprising:
a controller;
a sharing user display connected to the controller and operable to generate a screen image displaying a plurality of initial application window portions;
a sharing user input device connected to the controller;
a viewing user display connected to the controller;
the controller being operable to transmit a shared depiction of the screen image to the viewing user display; and
the controller being operable in response to operation of the sharing user input device revealing an additional application window portion on the sharing user display to prevent transmission of the additional application window portion to the viewing user display.

2. The video conferencing security facility of claim 1 including the controller being operable in response to operation of the sharing user input device to reveal an additional application window portion on the sharing user display, to display on the sharing user display a warning message.

3. The video conferencing security facility of claim 2 wherein the warning message includes displaying on the sharing user display the additional application window portion with warning indicia.

4. The video conferencing security facility of claim 3 wherein warning indica is selected from among indicia including highlighting, outlining, coloration, and hatching.

5. The video conferencing security facility of claim 1 including the controller being operable in response to operation of the sharing user input device to reveal an additional application window portion on the sharing user display, to display on the sharing user display a consent request message.

6. The video conferencing security facility of claim 5 including the controller being operable to respond to a consent response from the sharing user input device to display the additional application window portion on the viewing user display.

7. The video conferencing security facility of claim 1 wherein operation of the sharing user input device revealing an additional application window portion on the sharing user display includes the sharing user operating the sharing user input device to minimize one of the initial application window portions.

8. The video conferencing security facility of claim 1 wherein operation of the sharing user input device revealing an additional application window portion on the sharing user display includes the sharing user operating the sharing user input device to move one of the initial application window portions.

9. The video conferencing security facility of claim 1 wherein operation of the sharing user input device revealing an additional application window portion on the sharing user display includes the sharing user operating the sharing user input device to close one of the initial application window portions.

10. The video conferencing security facility of claim 1 wherein operation of the sharing user input device revealing an additional application window portion on the sharing user display includes the sharing user operating the sharing user input device to resize one of the initial application window portions.

11. The video conferencing security facility of claim 1 wherein operation of the sharing user input device revealing an additional application window portion on the sharing user display includes the sharing user operating the sharing user input device to minimize one of the initial application window portions.

12. The video conferencing security facility of claim 1 wherein the controller being operable in response to operation of the sharing user input device to consent to sharing of the additional application window portion to enable transmission of the additional application window portion to the viewing user display.

13. A method of preventing sharing of unwanted screen image portions between a sharing user and a viewing user, the method comprising the steps:
providing a sharing user screen, sharing user input device, and viewing user screen;
displaying a plurality of initial application window portions on the sharing user screen;
displaying the plurality of initial application window portions on the sharing user screen;
in response to the sharing user input device revealing an additional application window portion on the sharing user display, preventing display of the additional application window portion on the sharing user display;
in response to the sharing user input device revealing an additional application window portion on the sharing user display, requesting consent to display the additional application window portion on the sharing user display.

14. The method of claim 13 including the step of displaying the additional application window portion on the sharing user display in response of operation of the sharing user input device to grant consent to display the additional application window portion on the sharing user display.

15. The method of claim 13 wherein the step of requesting consent to display the additional application window portion on the sharing user display includes displaying on the sharing user display indicia associated with the additional application window portion.

16. The method of claim 15 wherein the step of displaying on the sharing user display indicia associated with the additional application window portion includes displaying on the sharing user display indica selected from among indicia including highlighting, outlining, coloration, and hatching.
